(19) United States
(12) Patent Application Publication
(10) Pub. No.: US 2018/0063247 A1
(43) Pub. Date: Mar. 1, 2018

(54) VEHICLE AND CONTROLLING METHOD THEREOF

(71) Applicant: HYUNDAI MOTOR COMPANY, Seoul (JP)

(72) Inventor: Dong In OH, Hwaseong-si (KR)

(73) Assignee: HYUNDAI MOTOR COMPANY, Seoul (KR)

(21) Appl. No.: 15/375,770

(22) Filed: Dec. 12, 2016

(30) Foreign Application Priority Data
Aug. 30, 2016 (KR) 10-2016-0110640

(51) Int. Cl. H04L 29/08; H04M 3/493; H04W 60/00; H04L 29/06; B60R 16/023

(52) U.S. Cl. CPC H04L 67/12; H04M 3/493; B60R 16/023; H04L 65/1073; H04W 60/00

(57) ABSTRACT

A vehicle includes: an input device configured to receive a command to execute a telematics function; a telematics terminal configured to provide the telematics function by communicating with a server via a network upon receiving the command; and a controller configured to determine whether or not the telematics terminal is registered in the network upon receiving the command to execute the telematics function and to inform a user that the telematics function is unavailable if the telematics terminal is not registered in the network.

### CROSS-REFERENCE TO RELATED APPLICATION(S)

This application claims the benefit of priority to Korean Patent Application No. 10-2016-0110640, filed on Aug. 30, 2016 in the Korean Intellectual Property Office, the entire disclosure of which is incorporated herein by reference.

### TECHNICAL FIELD

The present disclosure relates to vehicles.

### BACKGROUND

Telematics, a term formed by combining the terms telecommunications and informatics, refers to a next-generation service for providing information, and may be applied to vehicles by combining information technology (IT) with the automotive industry.

A telematics service provides traffic and driving information, information about dealing with an emergency, a remote vehicle diagnostic service, Internet, and other various services by utilizing wireless communication technology and global positioning system (GPS) technology.

### SUMMARY

An aspect of the present disclosure provides a vehicle informing a user of an unregistered state of the telematics terminal when the telematics terminal is not registered in a network, and also informing the user that a telematics service via the telematics terminal is available after the telematics terminal is registered in the network, and a method of controlling the vehicle.

Additional aspects of the disclosure will be set forth in part in the description which follows and, in part, will be obvious from the description, or may be learned by practice of the disclosure.

In accordance with one aspect of the present disclosure, a vehicle comprises: an input device configured to receive a command to execute a telematics function; a telematics terminal configured to provide the telematics function by communicating with a server via a network upon receiving the command; and a controller configured to determine whether or not the telematics terminal is registered in the network upon receiving the command to execute the telematics function via the input device and to inform a user that the telematics function is unavailable when the telematics terminal is not registered in the network.

The telematics terminal may attempt registration in the network when the telematics terminal is not registered in the network, and the controller may inform the user that the telematics function is available when the telematics terminal is registered in the network.

The telematics terminal may attempt registration in the network upon receiving the command input and may output a signal indicating completion of registration in the network to the controller upon completion of registration in the network.

The input device may comprise a button to execute an interactive voice response (IVR) call function.

The telematics terminal may perform communication via a CDMA method upon receiving a command input via the input device.

The controller may output a message requesting for confirmation of whether to execute the telematics function via a Long-Term Evolution (LTE) network.

The telematics terminal may communicate with the server upon receiving a command to agree with execution of the telematics function via the LTE network, and the telematics function is provided.

The telematics terminal may communicate with the server via at least one of CDMA and LTE methods.

In accordance with another aspect of the present disclosure, a method of controlling a vehicle may comprise: receiving a command to execute a telematics function via an input device; determining whether a telematics terminal is registered in a network; and informing a user that the telematics functions is unavailable when it is determined that the telematics terminal is not registered in the network.

The step of receiving the command to execute the telematics function via the input device may comprise receiving a command corresponding to a manipulation of a button to execute an interactive voice response (IVR) call function.

The step of informing the user that the telematics function is unavailable when it is determined that the telematics terminal is not registered in the network may comprise displaying a message indicating that the telematics function is unavailable on a display unit.

The method may further comprise informing the user that the telematics function is available upon completion of registration of the telematics terminal.

The step of informing the user that the telematics function is available upon completion of registration of the telematics terminal may comprise displaying a message indicating that the telematics function is available on the display unit.

The method may further comprise a step of performing registration of the telematics terminal in the network at the telematics terminal when the telematics terminal is not registered in the network.

The method may further comprise a step of outputting a message requesting confirmation whether to execute the telematics function via an LTE network.

The method may further comprise a step of providing the telematics function by communicating with the server via the LTE network upon receiving a command to agree with execution of the telematics function via the LTE network.

The outputting of the message requesting for confirmation whether to execute the telematics function via the LTE network may comprise displaying a message requesting confirmation whether to execute the telematics function via the LTE network.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a configuration of a telematics system.

FIG. 2 is an exterior view of a vehicle according to an exemplary embodiment.

FIG. 3 is an interior view of a vehicle according to an exemplary embodiment.

FIG. 4 is a control block diagram of a vehicle according to an exemplary embodiment.

FIG. 5 is a diagram illustrating a communication method between a vehicle and a server with regard to telematics functions according to an exemplary embodiment.

FIG. 6 is a flowchart illustrating a method of controlling a vehicle according to an exemplary embodiment.

### DETAILED DESCRIPTION

Reference will now be made in detail to the exemplary embodiments of the present disclosure, examples of which are illustrated in the accompanying drawings, wherein like reference numerals refer to like elements throughout.

In the drawings, the same or similar elements are denoted by the same reference numerals even though they are depicted in different drawings. In the following description of the present disclosure, a detailed description of known functions and configurations incorporated herein will be omitted when it may make the subject matter of the present disclosure rather unclear. The terms ‘part’ or ‘portion’ used herein may be implemented using a software or hardware component. According to an embodiment, a plurality of ‘parts’ or ‘portions’ may also be implemented using a unit or element and one ‘part’ or ‘portion’ may include a plurality of units or elements.

Also, it is to be understood that the terms “include” or “have” are intended to indicate the existence of elements disclosed in the specification, and are not intended to preclude the possibility that one or more other elements may exist or may be added.

As used herein, the singular forms “a”, “an” and “the” are intended to include the plural forms as well, unless the context clearly indicates otherwise.

The reference numerals used in operations are used for descriptive convenience and are not intended to describe the order of operations and the operations may be performed in a different order unless otherwise stated.

Hereinafter, operating principles and embodiments of the present disclosure will be described with reference to the accompanying drawings.

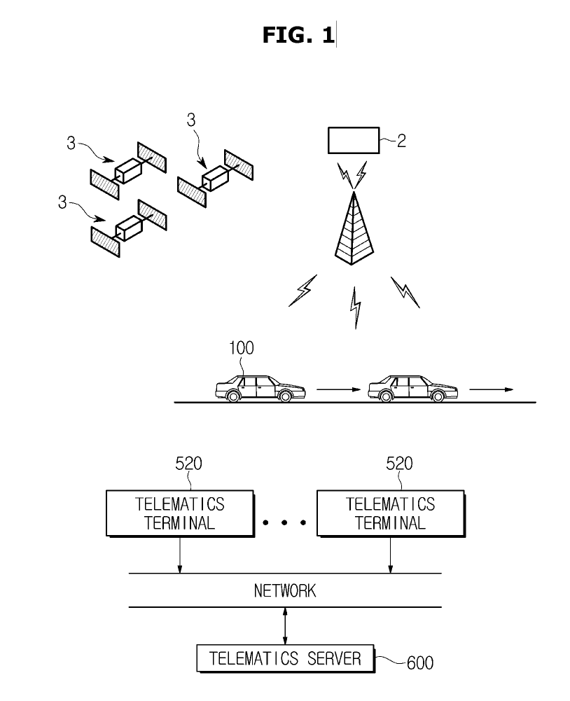

FIG. 1 is a view illustrating a configuration of a telematics system.

As illustrated in FIG. 1, a telematics system according to an exemplary embodiment includes a telematics terminal 520 provided at a vehicle 100 and a telematics server 600 provided at a telematics center 2.

According to an exemplary embodiment, telematics terminal 520 is installed in the vehicle 100, and may communicate with the telematics server 600 via a network. The telematics terminal 520 may be installed in the vehicle 100 as described above or may also be implemented using various terminals communicating with the telematics server 600 without being installed in the vehicle 100. For example, the telematics terminal 520 may be implemented using a computer or a portable terminal that may access the telematics server 600 via the network. In this regard, examples of the computer include notebook computers provided with web browsers, laptops, tablet PCs, and slate PCs. Examples of the portable terminal include handheld devices with portability and mobility suitable for wireless communications, such as Personal Communication System (PCS), Global System for Mobile Communication (GSM), Personal Digital Cellular (PDC), Personal Handy-phone System (PHS), International Mobile Telecommunications (IMT)-2000, Code Division Multiple Access (CDMA)-2000, W-Code Division Multiple Access (W-CDMA), and Wireless Broadband Internet (WiBro), Personal Digital Assistant (PDA) and smart phone.

The telematics terminal 520 may include a communication unit to communicate with the telematics server 600 as described above, and the communication unit may include one or more components. For example, the communication unit may include a wireless communication module and may further include at least one of a short-distance communication module and wired communication module.

Examples of the wireless communication module include a WiFi module, a WiBro module, and wireless communication modules supporting various wireless communication methods such as GSM, CDMA, W-CDMA, Time Division Multiple Access (TDMA), and Long Term Evolution (LTE).

The wireless communication module may include a communication port configured to connect a controller 510 to the network and a wireless communication interface including a transmitter configured to transmit a signal to provide a telematics service, e.g., a signal to execute an interactive voice response (IVR) service, and a receiver configured to a signal related to providing the telematics service. The wireless communication module may further include a signal converter module configured to modulate a digital control signal output from the controller 510 via the wireless communication interface into an analog wireless signal and demodulate the analog wireless signal received via the wireless communication interface into the digital control signal in accordance with control of the controller 510. The controller 510 included in the telematics terminal 520 may be implemented using a memory configured to store data in the form of algorithms and programs to control operation of components of the telematics terminal 520 and a processor configured to execute the operation by using the data stored in the memory. In this case, the memory and the processor may be implemented using separate chips or a single chip. The controller 510 may control the overall operation of the vehicle 100 in a state of being disposed in the telematics terminal 520 as described above or disposed outside the telematics terminal 520.

The short-distance communication module may transmit and receive signals via a wireless communication network in a short-distance and may be a Bluetooth module, a Radio Frequency Identification (RFID) module, a Wireless Local Access Network (WLAN) communication module, a NFC module, or a Zigbee module.

The wired communication module may be a various wired communication module such as a Controller Area Network (CAN) module, a Local Area Network (LAN) module, a Wide Area Network (WAN) module, or a Value Added Network (VAN) module and various cable communication modules such as Universal Serial Bus (USB), High Definition Multimedia Interface (HDMI), or Digital Visual Interface (DVI).

The telematics terminal 520 may receive GPS signals from at least three GPS satellites and calculate a current position of the vehicle 100 based on the GPS signals and map data. Also, the telematics terminal 520 may transmit position information of the vehicle 100 on a map to the telematics server 600 in a state that a route from the current position to a destination is set. In addition, the telematics terminal 520 may transmit driving images of the vehicle 100 acquired by a black box or other imaging devices and driving images of the vehicle 100 stored in the storage unit 180 to the telematics server 600. The storage unit 180 may be a storage unit included in the telematics terminal 520, a storage unit not included in the telematics terminal 520 but included in the vehicle 100, or an external memory not included in the vehicle 100. The storage unit 180 may be implemented using a non-volatile memory device such as cache, read only memory (ROM), programmable ROM (PROM), erasable programmable ROM (EPROM), electrically erasable programmable ROM (EEPROM), and flash memory, a volatile memory device such as random access memory (RAM), or a storage medium such as hard disk drive (HDD) and CD-ROM, without being limited thereto. The storage unit 180 may be a memory implemented as a separate chip from the processor or a single chip integrated with a processor.

The telematics server 600 may receive a variety of information such as driving images of the vehicle 100 from the telematics terminal 520 installed in the vehicle 100 and store the received information. Alternatively, the telematics server 600 may receive a signal related to execution of a telematics service and provide the telematics service related to the received signal.

According to the present exemplary embodiment, the vehicle 100 may provide an IVR call function among telematics functions. The IVR call function is a function of providing a service requested by the user via a voice call from a vehicle provided with the telematics terminal 520 described above when the user requests the telematics center 2 for the service.

In this case, the telematics server 600 of the telematics center 2 automatically identifies dialed number information of the vehicle 100 that sent the voice call and automatically connects the sent voice call of the user to a telematics service desired by the user.

For normal execution of the aforementioned IVR call function under given network environments, for example, under CDMA communication environments, the telematics terminal 520 should be registered in the network to allow the telematics center 2 to recognize the dialed number information of the vehicle 100.

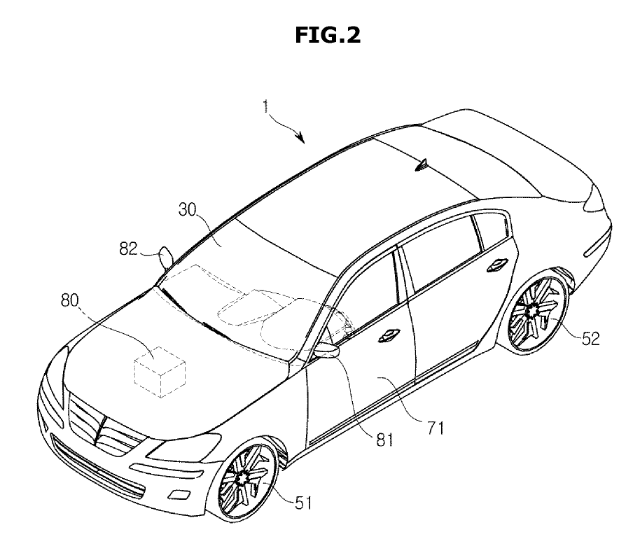

However, if the telematics terminal 520 is not registered in the network, the telematics server 600 cannot automatically recognize the dialed number information failing to automatically connect the voice call of the user to the desired service. Since the user is generally unaware of whether or not the telematics terminal 520 is registered in the network, the IVR call function is executed by the user regardless of registration of the telematics terminal 520 in the network. In this case, a staff of the telematics center 2 may response to the user in the vehicle 100 about the desired service. According to an exemplary embodiment, a vehicle and a method of controlling the same are provided to remove such inconvenience. Hereinafter, the vehicle and the method of controlling the same according to an embodiment will be described with reference to FIGS. 2 to 6.

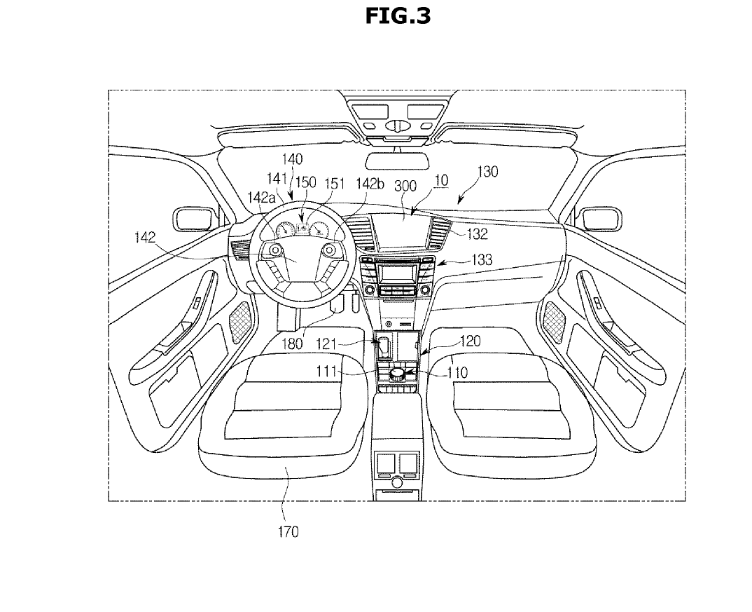

FIG. 2 is an exterior view of a vehicle according to an exemplary embodiment. FIG. 3 is an interior view of a vehicle according to the present exemplary embodiment.

Referring to FIG. 2, the vehicle 100 according to the present exemplary embodiment includes a body 1 defining an appearance of the vehicle 100, wheels 51 and 52 configured to move the vehicle 100, a driving device 80 configured to rotate the wheels 51 and 52, doors 71 configured to shield the inside of the vehicle 100 from the outside, a front glass 30 configured to provide a driver sitting in the vehicle 100 with a view in front of the vehicle 100, and side mirrors 81 and 82 configured to provide the driver with a view behind the vehicle 100.

The wheels 51 and 52 include front wheels 51 disposed at front portions of the vehicle 100 and rear wheels 52 disposed at rear portions of the vehicle 100.

The driving device 80 provides a rotational force to the front wheels 51 or the rear wheels 52 to move the body 1 forward or backward. The driving device 60 may include an engine configured to generate the rotational force via combustion of fossil fuels or a motor configured to generate the rotational force upon receiving power from a battery or a fuel cell. If the motor is used, the driving device 60 includes an inverter configured to control rotation of the motor.

The doors 71 are pivotally coupled to the body 1 at left and right sides and the driver may get into the vehicle 100 by opening the door 71, and the inside of the vehicle 100 may be shielded from the outside by closing the door 71.

The front glass 30, also called a windshield glass, is disposed at a front upper portion of the body 1 to allow the driver sitting in the vehicle 100 to see a view in front of the vehicle 100 through the front glass 3. Also, the side mirrors 81 and 82 include a left side mirror 81 disposed at the left side of the body 1 and a right side mirror 82 disposed at the right side of the body 1. The driver sitting in the vehicle 100 may check situations of left and right sides of the vehicle 100 via the side mirrors 81 and 82.

In addition, the vehicle 100 may include various sensors assisting the driver to recognize surrounding situations of the vehicle 100 by sensing obstacles around the vehicle 100. The vehicle 100 may also include various sensors to acquire driving-related information of the vehicle 100 such as the speed of the vehicle 100. Also, the vehicle 100 may further include sensors to acquire images of surrounding environments of the vehicle 100 including lanes.

Referring to FIG. 3, the vehicle 100 may include a gear box 120 and a dashboard provided with a center fascia 130, a steering wheel 140, and an instrument cluster 150.

The gear box 120 may be provided with a gear lever 121 for transmission of the vehicle 100. In addition, the gear box 120 may be provided with a dial controller 111 to allow the user to control functions of a multimedia apparatus including a navigation device 10 or an audio device 133 or main functions of the vehicle 100 and an input unit 110 including various buttons as illustrated in FIG. 3. The input unit 110 may include an input device 500 used to execute the aforementioned IVR call function and the input device 500 may be implemented using a button. The position of the input device 500 is not limited. By pressing the button, a request call for the IVR call function may be transmitted to the telematics center 2.

An air conditioner 132, the audio device 133, the navigation device 100, and the like may be installed in the center fascia 130.

The air conditioner 132 maintains the inside of the vehicle 100 in a pleasant state by controlling temperature, humidity, and cleanness of air, and air flow inside the vehicle 100. The air conditioner 132 may include at least one discharge port installed at the center fascia 130 and discharging air. The center fascia 130 may be provided with a button or dial to control the air conditioner 132. The user such as the driver may control the air conditioner 132 of the vehicle 100 by using the button or dial disposed at the center fascia 130. The air conditioner 132 may also be controlled by the button of the input unit 110 or the dial controller 111 installed at the gear box 120.

According to an exemplary embodiment, the center fascia 130 may be provided with the navigation device 10. The navigation device 10 may be installed as a built-in device in the center fascia 130 of the vehicle 100. According to an embodiment, the center fascia 130 may be provided with an input unit to control the navigation device 10. The input unit may also be installed at any other position than the center fascia 130. For example, the input unit of the navigation device 10 may be disposed around a display unit 300 of the navigation device 10. Alternatively, the input unit of the navigation device 10 may be installed at the gear box 120.

The steering wheel 140, which is a device to control a proceeding direction of the vehicle 100, may include a rim 141 gripped by the driver and a spoke 142 connected to a steering apparatus of the vehicle 100 and connecting the rim 141 with a hub of a rotating shaft for steering. According to an embodiment, the spoke 142 may include manipulators 142a and 142b to control various devices of the vehicle 100, for example, the audio device 133. In addition, the dashboard may be provided with the instrument cluster 150 to display a speed of the vehicle 100, a revolution per minute (RPM) of an engine, a fuel level, or the like. The instrument cluster 150 may include a cluster display 151 to display a state of the vehicle 100, driving-related information of the vehicle 100, and information related to controlling the multimedia apparatus.

The driver may drive the vehicle 100 by controlling the aforementioned various devices provided at the dashboard.

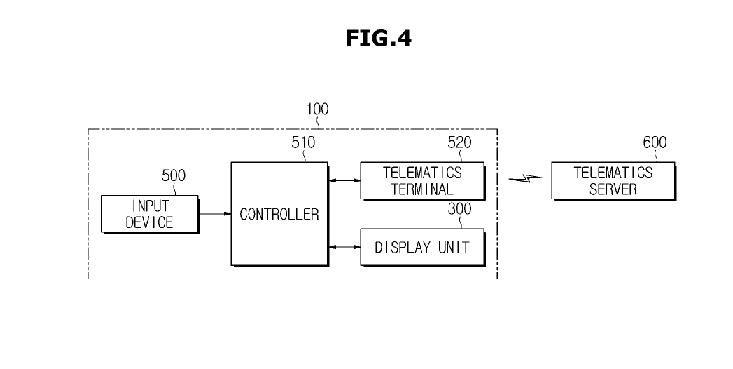

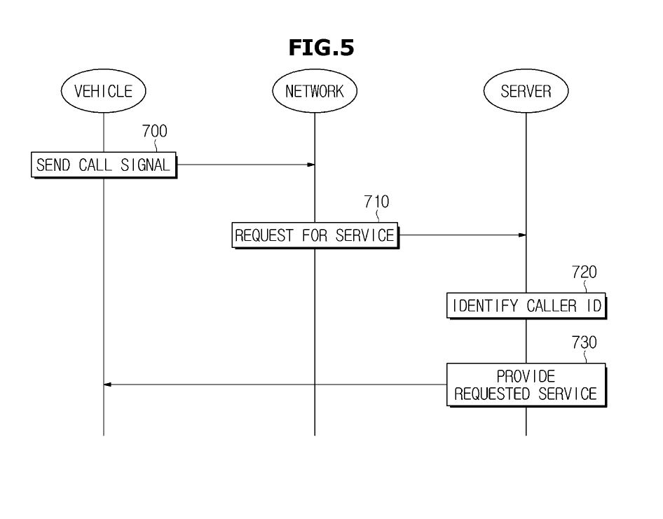

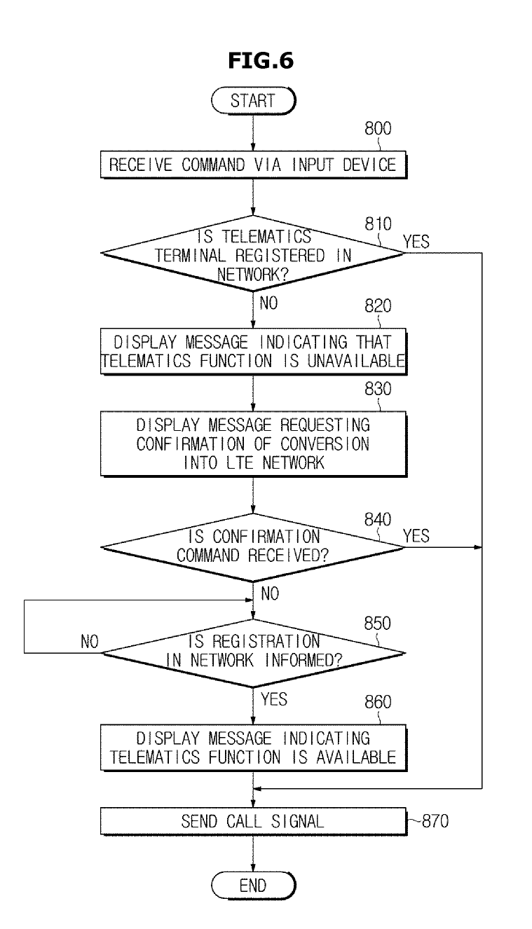

FIG. 4 is a control block diagram of a vehicle according to an exemplary embodiment. FIG. 5 is a diagram illustrating a communication method between a vehicle and a server with regard to telematics functions according to an exemplary embodiment. FIG. 6 is a flowchart illustrating a method of controlling a vehicle according to an exemplary embodiment.

Referring to FIG. 4, the vehicle 100 according to an exemplary embodiment includes the input device 500 configured to receive a command to execute a telematics function, the telematics terminal 520 configured to communicate with the telematics server 600 to execute the telematics function, the display unit 300 configured to display a message related to execution of the telematics function, and the controller 510 configured to control the telematics terminal 520 and the display unit 300 with regard to execution of the telematics function.

The input device 500 may include a button to receive, from the user, an input command to execute a telematics function, e.g., an IVR call, as described above. The button may be a hard key type button having a mechanical structure or a soft key type button displayed on the display unit 300 to receive a touch input command.

When the user manipulates the input device 500 to use the IVR call function, the controller 510 controls the telematics terminal 520 to send a call signal to the telematics server 600.

The controller 510 determines whether the telematics terminal 520 is registered in the network before sending out the call signal. If the telematics terminal 520 is already registered in the network, the controller 510 controls the telematics terminal 520 to send out the call signal.

As illustrated in FIG. 5, when the call signal is sent out (700), the network requests the telematics server 600 for an IVR call service (710) and the telematics server 600 identifies a caller ID, i.e., a dialed number (720), and provides an ARS voice guidance service to the telematics terminal 520 (730).

The user may select a desired telematics service in accordance with the ARS guidance. In this regard, the network may refer to a commercial communication network run by mobile carriers and provide CDMA or LTE communication environments.

As described above, the telematics terminal 520 communicating with the telematics server 600 should be registered in the network to receive the IVR call service under CDMA communication environments. The telematics terminal 520 is registered in the network via a process named power up registration by providing information about the telematics terminal 520 to the network, and the telematics server 600 may recognize the dialed number of the vehicle 100 based on this information.

If a call sending mode via a Voice over LTE (VoLTE) is not preset, the telematics terminal 520 sends out the call signal under CDMA communication environments. If the call sending mode via the VoLTE is preset, the telematics terminal 520 sends out the call signal via the VoLTE. In case of sending the call signal via the VoLTE, the telematics server 600 may provide the ARS voice guidance service to the telematics terminal 520 regardless of registration of the telematics terminal 520 in the network.

If the telematics terminal 520 is not registered in the network, the controller 510 displays a message indicating that the desired telematics function, e.g., the IVR call function, is not available, on the display unit 300 to inform the user of the unavailable IVR call function. In addition, if the telematics terminal 520 is not registered in the network, the telematics terminal 520 attempts registration thereof in the network and outputs a signal indicating completion of registration to the controller 510 upon completion of registration in the network.

The controller 510 displays a message indicating that the IVR call function is unavailable and also displays a message requesting for confirmation of conversion into an LTE network via the VoLTE on the display unit 300.

If the user inputs a command to agree with conversion into the LTE network with regard to the message requesting for confirmation of conversion into the LTE network, the telematics terminal 520 sends out the call signal via the VoLTE as described above. The user may input a command to agree with conversion into the LTE network by touching a given object of the display unit 300 or via a separate input device. The display unit 300 displaying messages related to the telematics function may be disposed at the center fascia 130 disposed at the center of the dashboard. The display unit 300 may be implemented using a light emitting diode (LED) and an organic light emitting diode (OLED), which are self-emitting devices or a liquid crystal display (LCD) provided with a separate light source. The display unit 300 may also be implemented using a touch screen panel (TSP) to receive a control command from the user and display information about operation corresponding to the input control command. The TSP may include a display configured display operation information and a control command input by the user, a touch panel configured to detect coordinates of a touch point of the body of the user, and a touch screen controller configured to judging the control command input by the user based on the coordinates of the touch point detected by the touch panel. The touch screen controller may recognize the control command input by the user by comparing the coordinates of the touch point of the user detected by the touch panel with coordinates of the control command displayed via the display.

If a command to disagree with conversion into the LTE network is received from the user with regard to the message requesting for the confirmation of conversion into an LTE network, the controller 510 waits until the telematics terminal 520 is registered in the network. Upon receiving a signal indicating completion of registration of the telematics terminal 520 in the network, the controller 510 displays a message indicating that the desired telematics function is available on the display unit 300.

When the telematics terminal 520 is registered in the network, the controller 510 controls the telematics terminal 520 to send out the call signal. As illustrated in FIG. 5, when the call signal is sent out, the network requests the telematics server 600 for the IVR call service and the telematics server 600 identifies the caller ID, i.e., the dialed number and then provides the ARS guidance service to the telematics terminal 520.

As described above, when the telematics terminal 520 not registered in the network sends the call signal to the telematics server 600, the telematics server 600 cannot identify the caller ID. In this case, the user needs to communicate with the staff of the telematics center 2 unnecessarily to obtain the desired service.

However, according to an exemplary embodiment, even when the telematics terminal 520 is not registered in the network, the user may be informed that the desired telematics service is not available during a registration process of the telematics terminal 520 in the network, and the telematics terminal 520 may send out the call signal upon completion of registration of the telematics terminal 520 in the network. In this case, since unnecessary communications between the user and the staff to obtain the desired service are not required, and the telematics service may be provided more efficiently.

At least one of the components of the vehicle illustrated in FIG. 4 may be deleted or another element may further be added thereto corresponding to performance thereof. In addition, it will be understood by those of ordinary skill in the art that interrelated positions of the elements may be modified in accordance with performance or structure of the vehicle 100.

Each of the components illustrated in FIG. 4 may be implemented using a ‘module’. The ‘module’ refers to a software component or a hardware component such as Field Programmable Gate Array (FPGA) or Application Specific Integrated Circuit (ASIC) and performs certain tasks. However, the module is not limited to the software or hardware component. The module may be configured to reside on an addressable storage medium or configured to execute on one or more processors. The functionality provided for the components and modules may be combined into fewer components and modules or further separated into additional components and modules.

Referring to FIG. 6, a method of controlling a vehicle will be described.

According to an exemplary embodiment, upon receiving a command via the input device 500 (800), the controller 510 of the vehicle 100 determines whether or not the telematics terminal 520 is registered in the network (810). When the telematics terminal 520 is registered in the network, the telematics terminal 520 sends out a call signal (870).

When the user manipulates the input device 500 to user the IVR call function, the controller 510 controls the telematics terminal 520 to send the call signal to the telematics server 600.

The controller 510 determines whether the telematics terminal 520 is registered in the network before outputting the call signal. If the telematics terminal 520 is already registered in the network, the controller 510 controls the telematics terminal 520 to send out the call signal.

After the call signal is output as illustrated in FIG. 5, the network requests the telematics server 600 for the IVR call service, and the server 600 identifies the caller ID, i.e., the dialed number and provides the ARS voice guidance service to the telematics terminal 520. The user may select the desired telematics service in accordance with the ARS voice guidance.

If the telematics terminal 520 is not registered in the network, the controller 510 displays a message indicating that the desired telematics function is unavailable on the display unit 300 (820). Then, the controller 510 displays a message requesting for confirmation of conversion into an LTE network on the display unit 300 and the telematics terminal 520 sends out the call signal upon receiving a confirmation command (870).

If the telematics terminal 520 is not registered in the network, the controller 510 informs the user by displaying a message indicating that the desired telematics function, e.g., the IVR call function, is unavailable on the display unit 300 to inform the user that the IVR call function is unavailable. Also, if the telematics terminal 520 is not registered in the network, the telematics terminal 520 attempts registration thereof in the network and outputs a signal indicating completion of registration to the controller 510 upon completion of registration in the network.

The controller 510 displays a message indicating that the IVR call is unavailable and also displays a message requesting confirmation of conversion into an LTE network via the VoLTE on the display unit 300.

If the user inputs a command to agree with conversion into the LTE network with regard to the message requesting for the confirmation of conversion into the LTE network, the telematics terminal 520 sends out the call signal via the VoLTE as described above.

If the confirmation command is not received, the controller 510 determines whether or not the signal indicating registration of the telematics terminal 520 in the network is received (850). Upon receiving the signal indicating completion of registration of the telematics terminal 520 in the network, the controller 510 displays a message indicating that the desired telematics function is available on the display unit 300 (860). Then, the telematics terminal 520 sends out the call signal (870).

Upon receiving a command to disagree with conversion into the LTE network from the user with regard to the message requesting for confirmation of conversion into the LTE network, the controller 510 waits until the telematics terminal 520 is registered in the network. Upon receiving a signal indicating completion of registration in the network from the telematics terminal 520, the controller 510 displays a message indicating that the desired telematics function is available on the display unit 300.

After the telematics terminal 520 is registered in the network, the controller 510 controls the telematics terminal 520 to send out the call signal. As illustrated in FIG. 5, after the call signal is sent out, the network requests the telematics server 600 for the IVR call service, and the telematics server 600 identifies the caller ID, i.e., the dialed number and provides the ARS voice guidance service to the telematics terminal 520.

As is apparent from the above description, if the telematics terminal is not registered in the network and the dialed number of the telematics terminal is not identified by the telematics server, an inconvenient communication between the user and the staff of the telematics service is not required according to an embodiment.

Although exemplary embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
an input device configured to receive a command to execute a telematics function;
a telematics terminal configured to provide the telematics function by communicating with a server via a network upon receiving the command; and
a controller configured to determine whether or not the telematics terminal is registered in the network upon receiving the command to execute the telematics function and to inform a user that the telematics function is unavailable if the telematics terminal is not registered in the network.

2. The vehicle according to claim 1, wherein the telematics terminal attempts registration in the network when the telematics terminal is not registered in the network, and
the controller informs the user that the telematics function is available when the telematics terminal is registered in the network.

3. The vehicle according to claim 1, wherein the telematics terminal attempts registration in the network upon receiving the command input via the input device and outputs a signal indicating completion of registration in the network to the controller upon completion of registration in the network.

4. The vehicle according to claim 1, wherein the input device comprises a button to execute an interactive voice response (IVR) call function.

5. The vehicle according to claim 1, wherein the telematics terminal performs communication via a CDMA method upon receiving the command input via the input device.

6. The vehicle according to claim 1, wherein the controller outputs a message requesting for confirmation of whether to execute the telematics function via a Long-Term Evolution (LTE) network.

7. The vehicle according to claim 6, wherein the telematics terminal communicates with the server upon receiving a command to agree with execution of the telematics function via the LTE network, and the telematics function is provided.

8. The vehicle according to claim 1, wherein the telematics terminal communicates with the server via at least one of CDMA and LTE methods.

9. A method of controlling a vehicle, the method comprising steps of:
receiving a command to execute a telematics function via an input device;
determining whether a telematics terminal is registered in a network; and
informing a user that the telematics functions is unavailable when it is determined that the telematics terminal is not registered in the network.

10. The method according to claim 9, wherein the step of receiving the command to execute the telematics function via the input device comprises receiving a command corresponding to a manipulation of a button to execute an interactive voice response (IVR) call function.

11. The method according to claim 9, wherein the step of informing the user that the telematics function is unavailable when it is determined that the telematics terminal is not registered in the network comprises displaying a message indicating that the telematics function is unavailable on a display unit.

12. The method according to claim 9, further comprising a step of informing the user that the telematics function is available upon completion of registration of the telematics terminal.

13. The method according to claim 12, wherein the step of informing the user that the telematics function is available upon completion of registration of the telematics terminal comprises displaying a message indicating that the telematics function is available on a display unit.

14. The method according to claim 9, further comprising a step of performing registration of the telematics terminal in the network at the telematics terminal when the telematics terminal is not registered in the network.

15. The method according to claim 9, further comprising a step of outputting a message requesting confirmation whether to execute the telematics function via an LTE network.

16. The method according to claim 15, further comprising a step of providing the telematics function by communicating with the server via the LTE network upon receiving a command to agree with execution of the telematics function via the LTE network.

17. The method according to claim 15, wherein the step of outputting the message requesting the confirmation whether to execute the telematics function via the LTE network comprises displaying a message requesting confirmation whether to execute the telematics function via the LTE network.
